(19) United States
(12) Patent Application Publication
(10) Pub. No.: US 2018/0229183 A1
(43) Pub. Date: Aug. 16, 2018

(54) EXHAUST GAS PURIFYING CATALYST

(71) Applicant: DENSO CORPORATION, Kariya-city, Aichi-pref. (JP)

(72) Inventors: Yoichi KADOTA, Kariya-city, Aichi-pref. (JP); Yasushi TAKAYAMA, Kariya-city, Aichi-pref. (JP)

(21) Appl. No.: 15/751,285

(22) PCT Filed: Jul. 29, 2016
(86) PCT No.: PCT/JP2016/072404

§ 371 Date: Feb. 8, 2018

(30) Foreign Application Priority Data
Aug. 18, 2015 (JP) 2015-161087

(51) Int. Cl. B01D 53/94; B01J 23/63; B01J 35/04; F01N 3/28; F01N 3/08

(52) U.S. Cl. CPC B01D 53/945; B01J 23/63; B01J 37/0244; F01N 3/2828; F01N 3/0814; B01J 35/04

(57) ABSTRACT

An exhaust gas purifying catalyst provided with a honeycomb structured porous material, a first catalyst consisting of Pd, a coating layer which is formed on a surface of the porous material and a second catalyst consisting of Rh which is loaded onto the coating layer. The porous material contains a catalyst support consisting of a ceria-zirconia solid solution, a composite consisting of alumina and an inorganic binder. A content of the catalyst support in the porous material exceeds 50 parts by mass of a total 100 parts by mass for the catalyst support and the composite. The coating layer is provided with a catalyst support consisting of ceria-zirconia solid solution.

### TECHNICAL FIELD

The present disclosure relates to an exhaust gas purifying catalyst, and more particularly relates to an exhaust gas purifying catalyst provided with a honeycomb structure porous material containing a catalyst support consisting of a ceria-zirconia solid solution, a first catalyst consisting of Pd and a second catalyst consisting of Rh.

### RELATED ART

Honeycomb structure porous materials consisting of cordierite or silicon carbide (Sic) are used to purify exhaust gas emitted from a vehicle. Specifically, an exhaust gas purifying catalyst provided with a honeycomb structure loaded with a catalyst support consisting of a ceria-zirconia solid solution, for example, and a noble metal catalyst loaded which are loaded via an inorganic binder is used.

As disclosed in JP literature 1, recently, honeycomb structure porous materials formed from a ceria-zirconia catalyst support, for example, and alumina has been developed. The porous material is loaded with Pd and Rh noble metal catalysts to purify hydrocarbons (specifically, HC) and NOx in an exhaust gas.

Porous materials that contain these kinds of catalyst supports elicit remarkable purifying performance for HC even in low-temperature conditions when an engine is started, as the thermal capacity can be comparably lower than porous materials consisting of cordierite, for example.

### CITATION LIST

### Patent Literature

[Patent Literature 1] JP2015-85241A

### SUMMARY OF INVENTION

### Technical Problem

After the engine starts, particularly during high load operation, it is necessary to use an Rh catalyst which has high purifying abilities for NOx, in order to obtain a high NOx purifying performance. However, in this regard if Pd and Rh noble metal catalysts are both loaded on the same porous material, a Pd and Rh alloy may form through heating when the exhaust gas purifying catalyst is produced or used, thus, a function of purifying exhaust gas deteriorates.

The inventors of the present disclosure produced a porous material formed of a catalyst support. The porous material is provided with a coating layer consisting of a catalyst support, which is coated on a surface thereof, the porous material and the coating layer were each provided with different noble metal catalysts, in a preliminary test. As a result, the alloying of the noble metals was avoided and a decrease of the catalyst performance was also suppressed. It was however discovered that the coating layer easily detached from the porous material, as an interface between the porous material and the coating layer becomes flat, compared to a conventional porous material formed from cordierite, for example.

In view of the above issues, the present disclosure aims to provide an exhaust gas purifying catalyst in which a decrease of an exhaust gas purifying function and detachment of a coating layer is suppressed.

A mode of the present disclosure is a honeycomb structure porous material, a first catalyst consisting of Pd loaded on the porous material, a coating layer formed on a surface of the porous material, and a second catalyst consisting of Rh loaded on the coating layer. The porous material contains a catalyst support consisting of a ceria-zirconia solid solution, a composite consisting of alumina, and an inorganic binder. A content of the catalyst support in the porous material exceeds 50 parts by mass of a total of a 100 parts by mass of the catalyst support and the composite. The coating layer which consists of a catalyst support is provided in the exhaust gas purifying catalyst. The catalyst support consists of a ceria-zirconia solid solution.

The exhaust gas purifying catalyst is provided with the honeycomb structured porous material formed from the catalyst support described above, for example. As a result, a thermal capacity of the porous material is decreased compared to a conventional porous material consisting of cordierite, for example, thus a purifying performance for HC may be enhanced under low-temperature environmental conditions at the starting point of an engine. The exhaust gas purifying catalyst is also provided with the coating layer formed on the surface of the porous material, and the first catalyst consisting of Pd and the second catalyst consisting of Rh loaded respectively on the porous material and the coating layer. As a result, according to the exhaust gas purifying catalyst, suppression of the first and the second catalyst forming an alloy and a decrease of NOx purifying performance after the engine starts, may be achieved. Furthermore, both a high HC purifying performance at the start-up of the engine and a high NOx purifying performance after the engine is started may be achieved.

The exhaust gas purifying catalyst has a high content ratio of the catalyst support in the porous material. In this respect, although the porous material formed of the catalyst support is provided with the coating layer formed thereon, the detachment of this coating layer may be prevented. Effects of the prevention of the detachment of the coating layer are described in detail in an experiment example by comparison of an example according to an embodiment and a comparative example.

According to the mode described hereinabove, an exhaust gas purifying catalyst, which can suppress the decrease of the exhaust gas purifying performance and detachment of the coating layer may be provided.

### BRIEF DESCRIPTION OF DRAWINGS

In the accompanying drawings:

FIG. 1 is a perspective view of an exhaust gas purifying catalyst according to a first embodiment;

FIG. 2 is a cross-sectional view of a section of the exhaust gas purifying catalyst in an axial direction, according to the first embodiment;

FIG. 3 is an enlarged cross-sectional view of a septal wall of the exhaust gas purifying catalyst according to the first embodiment; and

FIG. 4 is a scanning electron-microscopic image showing an interface between a porous material and a coating layer of the exhaust gas purifying catalyst according to the first embodiment.

### EMBODIMENTS OF THE DISCLOSURE

### First Embodiment

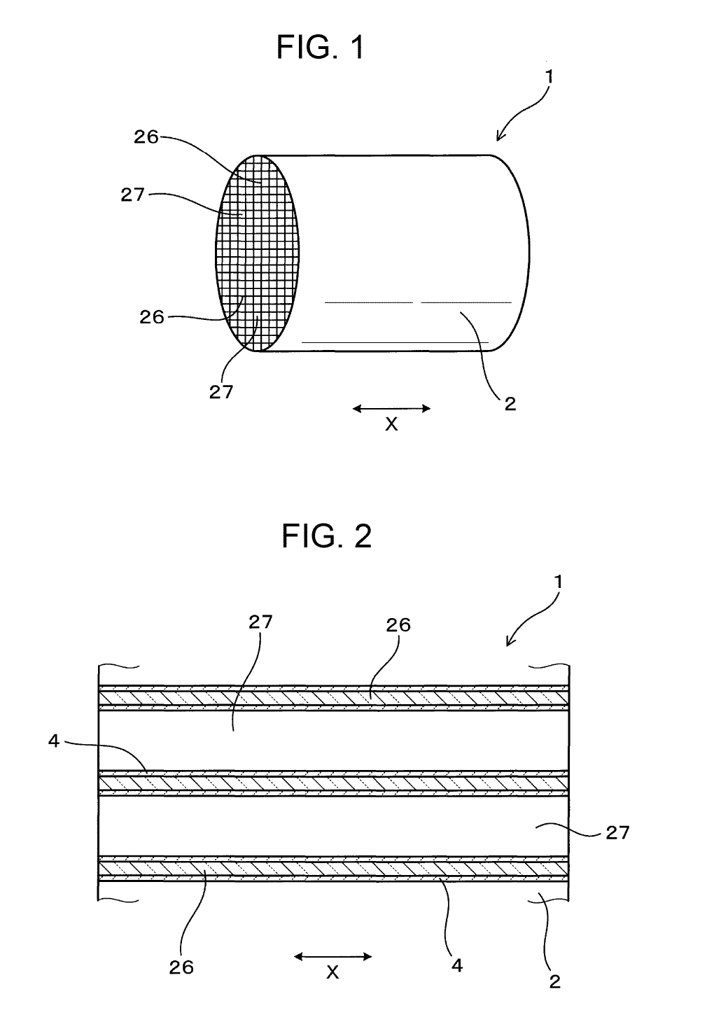

A preferred embodiment for an exhaust gas purifying catalyst will next be described with reference to FIGS. 1 to 3. As shown in FIG. 1 and FIG. 2, the exhaust gas purifying catalyst 1 according to the embodiment is provided with a honeycomb structure porous material 2 and a coating layer 4 formed on a surface of the porous material. The coating layer 4 is preferably porous to facilitate passing of an exhaust gas through the coating layer 4. The porous material 2 has a column shape, for example, provided with septal walls 26 formed as a lattice shape on an inside thereof, and a large number of cells 27 provided to extend in an axial direction X which surround the septal wall 26. The porous material 2 may have a column shape as shown in the embodiment, or a polygonal prism shape, such as a cuboid shape. The septal walls 26 may be configured so that that the cells 27 are a square shape, in a radial cross section direction of the porous material 2 (specifically a cross section in an axial direction X and perpendicular direction) as shown in the embodiment. The septal walls 26 may also be configured so that the cells 27 are formed in a polygonal shape, for example, a triangular shape, a hexagonal shape, and an octagonal shape, and may also be formed in a circular shape, in the radial cross-sectional direction of the porous material 2.

The porous material 2 contains catalyst support consisting of a ceria-zirconia solid solution, a composite consisting of alumina and an inorganic binder. The catalyst support is a ceria-zirconia solid solution of zirconium melted (solubilized) in ceria, however, in addition to zirconium, La (Lanthanum) or Y (Yttrium) rare earth elements may also be melted in the solid solution. Alumina, silica, zirconia or titanium, for example, may be used as an inorganic binder. Alumina is preferably used as the inorganic binder. As shown in FIG. 2, on the surface of the honeycomb structure porous material 2, that is, on a surface of the septal wall 26 the coating layer 4 consisting of a catalyst support is formed. The catalyst support of the coating layer 4 essentially consists of a ceria-zirconia solid solution. FIG. 4 is an example of a scanning electron microscopic image showing an interface between the septal wall 26 and the coating layer 4 of the exhaust gas purifying catalyst 1.

The interface between the porous material 2 (more specifically the septal wall 26) and the coating layer 4 is shown as a white line L in FIG. 4. A region that is on a lower side of this line L is specifically the septal wall 26, and a region that is on an upper side thereof is specifically the coating layer 4. In the porous material 2, the catalyst 21 support consisting of ceria-zirconia solid solution is shown in a grey shade which is nearest to white, a composite 22 consisting of alumina is shown as a grey shade nearest to black, and an inorganic binder 23 consisting of alumina is shown in a grey shade which is a shade between both of the shades mention above. Additionally, minute pores 25 which are shown in black in FIG. 4 are formed therebetween catalyst support 21 and therebetween clustered composite 22. The minute pores 25 are also formed between the catalyst support 21 and the composite 22, and between the composite 22 and the inorganic binder 23, for example. As shown in FIG. 4, the inorganic binder 23 forms a matrix, and the catalyst support 21 and composite 22 are dispersed in the matrix, provided in the porous material 2. A content of the catalyst support 21 exceeds 50 parts by mass of a total 100 parts by mass of the catalyst support 21 and the composite 22 in the porous material 2.

In contrast, the coating layer 4 is formed from the catalyst support 41 consisting of a ceria-zirconia solid solution which is shown in a grey color. The coating layer 4 is provided with a large number of pores 45 shown in black. The coating layer 4 may also include a small amount of an inorganic binder consisting of alumina, for example.

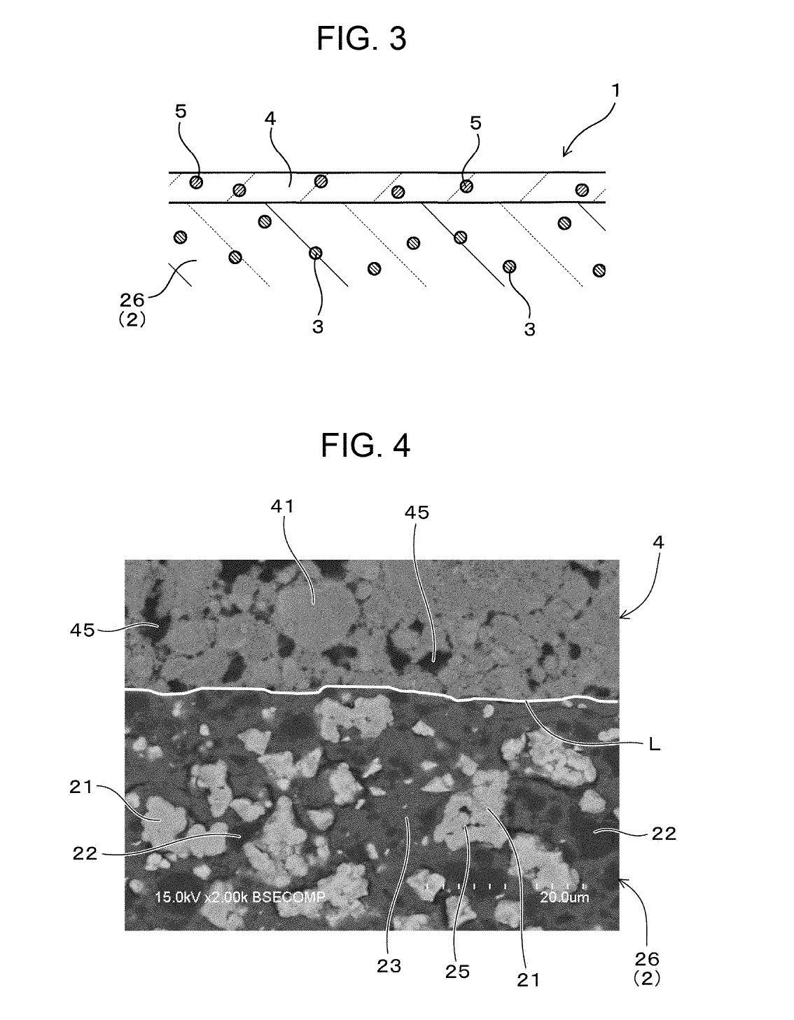

As shown in FIG. 3, a first catalyst 3 consisting of Pd is loaded on the porous material 2. Specifically, the first catalyst 3 is loaded on the septal wall 26 of the porous material 2. Additionally, a second catalyst consisting of RH is loaded on the coating layer 4. It is noted that the first and second catalysts are not shown in the SEM image in FIG. 4.

Next, a manufacturing method of the exhaust gas purifying catalyst according to the first embodiment will be described. Firstly, the ceria-zirconia catalyst support, the alumina composite and a raw material for the inorganic binder were mixed together. Each type of inorganic binder sol, for example, alumina sol and silica sol, may be used as the raw material for the inorganic binder. An amount of the catalyst support contained in the mixture was adjusted to exceed 50 parts by mass of a total 100 parts by mass of the catalyst support and the composite.

Next, by adding an organic binder, an auxiliary agent and water, for example, to the mixture, a clay was obtained. The clay was then formed in a shape of the honeycomb structure and a mold was obtained. The firing temperature was in a range of 700 to 1200° C. for a firing duration of 2 to 50 hours, for example.

Next, the resultant porous material obtained was immersed in a palladium salt solution, such as palladium sulfate, and the solution was impregnated into the porous material. The porous material was then dried. In this way by repeatedly immersing and drying the porous material, a desired amount of palladium salt was loaded on the porous material. Next by heating the porous material, the first catalyst consisting of Pd was loaded on the porous material. It is noted that the heating temperature was in a range of 300 to 600° C., for a duration of between 0.5 to 5 hours, for example.

A powder form catalyst support consisting of the ceria-zirconia was mixed in a rhodium salt solution, for example, rhodium sulfate to form a mixed solution. The mixed solution was then dried and a powder obtained. Next, by heating this powder, a powder with the catalyst support loaded with rhodium was obtained. This powder will be referred to as a catalyst powder, hereon.

A slurry used to form the coating layer was obtained by mixing the catalyst powder with water. An inorganic binder raw material, for example, an alumina sol, may also be added to the slurry used to form the coating layer. In order to increase an amount of the catalyst, the inorganic binder was added at an amount of preferably less than 10 parts by mass relative to a 100 parts by mass of the catalyst powder. The porous material loaded with the first catalyst, as described above, was then coated with the slurry used to form the coating layer. After coating, drying was performed, and by further heating, the porous material provided with the coating layer provided on the surface thereof was formed. The heating temperature, for example, is in a range of 300 to 600° C. for a duration of 0.5 to 5 hours, for example. In this way, the exhaust gas purifying catalyst provided with the porous material 2, the first catalyst 3 loaded on to the porous material 2, the coating layer 4 formed on the surface of the porous material 2, and the second catalyst 5 loaded on the coating layer 4 was obtained.

Next, a working effect of the exhaust gas purifying catalyst according to the embodiment will be described. With reference to FIGS. 1 to 3, the exhaust gas purifying catalyst 1 is provided with the honeycomb structured porous material 2, and the coating layer 4 provided on the surface of the porous material 2. The porous material 2 and the coating layer 4 are provided respectively with the first catalyst 3 comprising of Pd and the second catalyst 5 comprising of Rh which are physically separated, thus, the prevention of Pd and the Rh forming an alloy is achieved. As a further result, a decrease of the exhaust gas purifying performance may also be suppressed.

The pores on the surface of the porous material 2 formed by the catalyst support 21 are small (FIG. 4). In this regard, it is difficult for particles which form the coating layer 4 to enter inside the pores on the surface of the porous material 2, thus an anchor effect between the coating layer 4 and porous material 2 is difficult to obtain when the coating layer 4 and the porous material 2 are joined, as the interface between the porous material 2 and coating layer 4 is formed flat, as shown in FIG. 4. As a result, the adhesion between the coating layer and porous material has a tendency to decrease. According to the present embodiment, a content of the catalyst support 21 contained in the porous material 2 exceeds 50 parts by mass of a total 100 parts by mass of the catalyst support 21 and the composite 22, thus the content ratio of the catalyst support 21 in the porous material 2 is high. As a result, although the interface between the porous material 2 and the coating layer 4 is flat as mention above, prevention of the coating layer 4 detaching from the porous material 2 may be accomplished. In order to enhance the prevention of the coating layer 4 detaching from the porous material 2, the content of the catalyst support 21 in the porous material 2 is more preferably larger than 70 parts by mass of a total 100 parts by mass of the catalyst support 21 and the composite 22, described hereafter in an experiment example.

A content of the inorganic binder, such as alumina, in the coating layer 4 is preferably less than 10 parts by mass relative to a 100 parts by mass of the ceria-zirconia solid solution. In this case, a decrease of NOx purifying performance by reaction of the alumina, for example, inorganic binder component and the second catalyst (specifically, Rh) may be suppressed. In the same view, the content of the inorganic binder is more preferably less than 5 parts by mass, and further preferably less than 3 parts by mass, relative to a 100 parts by mass of ceria-zirconia solid solution. Additionally, a content of ceria in the ceria-zirconia solid solution is preferably less than 30% mass weight. In this case, decrease of the NOx purifying performance of the exhaust gas purifying catalyst 1 caused by interaction of ceria which has a comparatively high alkalinity and the second catalyst (specifically Rh), may be suppressed. This reaction of ceria and the second catalyst occurs easily when the ceria content is increased to exceed 30% mass weight. In this regard, the content of ceria is more preferably less than 15% mass weight and further preferably less than 10% mass weight in the ceria-zirconia solid solution.

### Experiment Example

In the example, a plurality of exhaust gas purifying catalysts provided with different contents of catalyst support ceria contained in the porous material (embodiment example 1, embodiment example 2 and comparative example 1) and an exhaust gas purification without a coating layer formed on a surface of the porous material (comparative example 2) were each constructed. An exhaust gas purifying performance and a detaching rate of the plurality of exhaust gas purifying catalysts was evaluated.

Specifically, a mixture of 30 parts by mass of alumina composite particles having an average particle diameter of 20 μm, 70 parts by mass of ceria-zirconia catalyst support particles having an average diameter of 10 μm, 10 mass parts dry weight of inorganic binder particles formed from alumina sol, 15 parts by mass of organic binder, 1 mass part of a forming auxiliary agent and 33 parts by mass of water was mixed using a mixing machine to obtain a clay. It is to be understood that Alumina sol AS-520 manufactured by Nissan Chemical Industries Ltd., was used as the inorganic binder. Additionally, Methylcellulose 65MP4000 manufactured by Matsumoto Yushi-Seiyaku Co., Ltd was used as an organic binder, and UNILUB® 50MB26 produced by NIPPON OIL & FAT (NOF) Corporation was used as the auxiliary forming agent. An MS dispersion mixer DS3-10 produced by Moriyama Co., Ltd was used. It is also noted that an average particle diameter refers to a particle radius at an estimated volume value of 50% for the particle distribution calculated by a laser diffraction/scatter method.

Next, the clay was formed in the honeycomb structure to obtain a mold. Thereafter, the mold was thoroughly dried using a microwave drying machine and a hot air dryer. The mold was then sintered at 1050° C. for 10 hours to obtain a honeycomb structured porous material provided with a radius of 103 mm and a length of 105 mm.

Subsequently, by immersing the porous material in 1% mass weight Pd concentration of palladium sulfate solution for a predetermined period, the solution was impregnated in the porous material. Next, the porous material was dried using a drying machine set at 80° C. By repeating the impregnation and drying of the porous material, a pre-determined amount of Pd was loaded on the porous material. Next, by heating the porous material at 500° C. in air atmospheric air, a porous material loaded with the first catalyst consisting of Pd was obtained.

Next, rhodium sulfate solution was mixed with a ceria-zirconia complex oxide powder having a ceria-zirconia mass ratio of 10:90 (specifically ceria:zirconia) to form a mixed solution. The mixed solution was then heated in a drying machine set at 80° C. for one day. A resultant powder obtained was then heated at 500° C. for 1 hour in atmospheric air, to obtain a catalyst powder of a ceria-zirconia catalyst support loaded with Rh. Next, 100 g of the catalyst powder, 2 g of alumina-sol (dry weight) and 400 g of purified water were mixed to form a slurry, which was used to form the coating layer. The Alumina sol AS-520 manufactured by Nissan Chemical Industries Ltd., was used.

The porous material loaded with the first catalyst was then immersed in the coating layer-forming slurry. The porous material was taken out of the slurry and excess slurry on the porous material was blown off. The porous material was thus coated as described above with the coating layer-forming slurry. A coating layer may also be provided using other known catalyst coating methods. After the coating was performed, the porous material was dried in a drying machine set at 80° C. for one day. Next, by heating the porous material at 500° C. for 1 hour under atmospheric conditions the coating layer was thus formed on the surface thereof. The exhaust gas purifying catalyst 1 provided with the porous material 2 containing the catalyst support essentially comprising ceria-zirconia solid solution, the composite essentially comprising alumina, and the inorganic binder, the first catalyst 3 essentially comprising Pd loaded on the porous material 2, and the coating layer 4 loaded with the second catalyst 5 essentially comprising Rh which was formed on the surface of the porous material was obtained (with reference to FIG. 1 to FIG. 4). The exhaust gas purifying catalyst 1 as described above was provided as an embodiment example 1. The embodiment example 1 was provided with alumina and the ceria-zirconia solid solution (also referred to as CZ) at a mass ratio of 30:70 (specifically, alumina:CZ) contained in the porous material.

Two additional exhaust gas purifying catalysts were also constructed in the same manner as the embodiment example 1, with the exception of a ratio of alumina and CZ in the porous material which was changed. The two additional exhaust gas purifying catalysts was respectively an embodiment example 2 and a comparative example 1. A mass ratio of the alumina and ceria-zirconia (also referred to as CZ) in the porous material of the embodiment example 2 was 10:90 (that is, alumina:CZ). Furthermore, the mass ratio of alumina and ceria-zirconia in the porous material of the comparative example 1 was 50:50 (specifically, alumina:CZ).

Additionally, an exhaust gas purifying catalyst was constructed without a coating layer. The exhaust gas purifying catalyst without the coating layer was used as the comparative example 2. The comparative example 2 was constructed by obtaining the porous material loaded with the first catalyst consisting of Pd in the same manner as described for the embodiment example 1. The porous material was then immersed for the predetermined time in a rhodium sulfate solution, and the solution was thus impregnated into the porous material. The porous material was then dried in a drying machine set at 80° C. In this way, the porous material was loaded with a predetermined amount of Rh by repeating the impregnation of the solution and the drying process. Next, by heating the porous material at 500° C. under air atmospheric conditions, the second catalyst consisting of Rh was loaded on the porous material. The comparative example 2 exhaust gas purifying catalyst provided with the first catalyst consisting of Pd and the second catalyst consisting of Rh loaded respectively onto the porous material was obtained.

### [Durability Test]

Each embodiment example and a comparative example of the exhaust gas purifying catalyst was set inside an exhaust pipe of a gasoline engine, and a durability test of heating at 980° C. for 20 hours was carried out inside the exhaust pipe.

### [Evaluation of NOx Purification Rate (%)]

After the durability test, each embodiment example and comparative example exhaust gas purifying catalyst was set inside the exhaust pipe of the gasoline engine, and an entrance of the exhaust gas purifying catalyst was set at a temperature of 400° C. A NOx concentration C₀ at an entrance-side of the exhaust gas purifying catalyst and a NOx concentration C₁ at an exit-side thereof was respectively analyzed using a gas analysis apparatus, and the NOx purification percentage (%) was calculated using the formula (1) below. Results are shown in table 1.

P=100 100×(C₀−C₁)/C₀ (1)

### [Detaching Rate Evaluation]

After the durability test, the detaching rate (%) was measured as described below. Firstly, the weight of the porous material before the coating layer was formed expressed as W₀ was measured for the embodiment example 1, the embodiment example 2 and comparative example 1. The weight of the porous material after the coating layer was formed expressed as W₁ was also measured. Additionally, the weight of the porous material after the durability test expressed as W2 was also measured.

It is noted that the measurement of the weight was performed after each porous material was dried in a dryer set at 80° C. for 5 hours, in order to avoid the effects of moisture adsorption. The detaching rate R (%) was calculated using the formula below. These results are shown in Table 1. It is noted that the comparative example 2 is not provided with the coating layer thus the evaluation is omitted.

R=100×(W₁−W₂)/(W₁−W₀) (2)

TABLE 1

| | Composition of porous material (parts | | | Coating | NOx | Layer |
|---|---|---|---|---|---|---|
| | mass weight) | | | layer | purification | detached |
| Examples | Al₂O₃ | CZ | Binder (I) | yes/no | (%) | (%) |
| Embodiment 1 | 30 | 70 | 10 | yes | 88.3 | 0.2 |
| Embodiment 2 | 10 | 90 | 10 | yes | 96.4 | 0.1 |
| Comparative 1 | 50 | 50 | 10 | yes | 65.8 | 14.4 |
| Comparative 2 | 30 | 70 | 10 | no | 59.6 | — |

As shown in Table 1, the NOx purifying percentage of the embodiment examples is high. The reason for this is that the embodiment examples (embodiment example 1 and embodiment example 2) are provided with the porous material and the coating layer, each of which is loaded respectively with the first catalyst consisting of Pd and the second catalyst consisting of Rh. As a result, the first catalyst and the second catalyst are physically separated from each other and it is considered that formation of a Pd and Rh alloy is thus prevented. In this respect, the comparative example 2 is provided with both the first and second catalyst loaded on the porous material, thus alloying of Pd and Rh occurs easily, decreasing the NOx purification rate as a result, as shown in Table 1. Additionally, as the comparative example 2 was provided with the porous material loaded with the second catalyst comprising of Rh, it is considered that the alumina composite and the Rh contained in the porous material reacted with each other, thus decreasing the NOx purifying rate due to loss of activity of the second catalyst.

In the embodiment example, the content of the catalyst support in the porous material exceeded 50 parts by mass of a total 100 parts by mass of the catalyst support and the composite. That is, a content ratio of the catalyst support in the porous material was high. As a result, detaching of the coating layer was remarkably low, and the detaching of the coating layer from the surface of the porous material was prevented, as shown in Table 1. In contrast, also as shown in Table 1, the detaching ratio (%) was high for the comparative example 1, which has a small amount of the catalyst support contained in the porous material. As described above, since the detaching rate of the coating layer was high in the comparative example 1 and partial detachment of the coating layer occurred after the durability test, the NOx purification rate also decreased after the durability test. By comparing the embodiment examples and the comparative examples, it was found that detachment of the coating layer was preventable by increasing the predetermined content of the catalyst support in the porous material.

The preferred embodiment of the present disclosure has been described hereinabove, however the present disclosure is not limited to the preferred embodiment described. That is, various other embodiments may be adopted within the scope of the present disclosure.

### SYMBOLS

1 exhaust gas purifying catalyst
2 porous material
3 first catalyst
4 coating layer
5 second catalyst

1. An exhaust gas purifying catalyst comprising;
a honeycomb structured porous material;
a first catalyst consisting of palladium loaded on to the porous material;
a coating layer formed on a surface of the porous material;
a second catalyst consisting essentially of rhodium loaded onto the coating layer, wherein,
the porous material contains, a catalyst support consisting essentially of a ceria-zirconia solid solution; a composite consisting essentially of alumina, and an inorganic binder, a content of the catalyst support exceeding 50 parts by mass of a total 100 parts by mass, the total 100 parts by mass being the catalyst support and the composite, and
the coating layer comprises a catalyst support which consists of a ceria-zirconia solid solution.

2. The exhaust gas purifying catalyst according to claim 1, wherein,
the catalyst support has a content which exceeds 70 parts by mass of a total 100 parts by mass, the 100 parts by mass being the catalyst support and the composite, in the porous material.

3. The exhaust gas purifying catalyst according to claim 1, wherein,
the coat layer contains an inorganic binder, and an amount of the inorganic binder contained in the coat layer is less than 10 parts by mass for 100 parts by mass of ceria zirconia solid solution.

4. The exhaust gas purifying catalyst according to claim 1, wherein,
the ceria-zirconia solid solution in the coat layer has a mass content of ceria which is less than 30%.

5. The exhaust gas purifying catalyst according to claim 2, wherein,
the coat layer contains an inorganic binder, and an amount of the inorganic binder contained in the coat layer is less than 10 parts by mass for 100 parts by mass of ceria zirconia solid solution.

6. The exhaust gas purifying catalyst according to claim 2, wherein,
the ceria-zirconia solid solution in the coat layer has a mass content of ceria which is less than 30%.

7. The exhaust gas purifying catalyst according to claim 3, wherein,
the ceria-zirconia solid solution in the coat layer has a mass content of ceria which is less than 30%.
